(19) United States
(12) Patent Application Publication
(10) Pub. No.: US 2018/0017947 A1
(43) Pub. Date: Jan. 18, 2018

(54) SYSTEM AND METHOD FOR OPTIMIZING BUILDING SYSTEM CONTROL OF PATIENT ROOMS TO ENHANCE PATIENT OUTCOMES

(71) Applicant: SIEMENS INDUSTRY, INC., ALPHARETTA, GA (US)

(72) Inventors: Timur Kupa, Crystal Lake, IL (US); Pornsak Songkakul, Mequon, WI (US)

(21) Appl. No.: 15/208,692

(22) Filed: Jul. 13, 2016

(51) Int. Cl. G05B 13/02; F24F 11/00; G06F 3/16; H05B 37/02

(52) U.S. Cl. CPC G05B 13/021; H05B 37/02; F24F 11/006; G06F 3/165

(57) ABSTRACT

A system and method is provided that facilitates optimizing building system control of patient rooms to enhance patient outcomes. A processor may be configured to determine a customized environmental condition for a medical condition that contributes to a positive medical outcome for the medical condition based on environmental conditions associated with each of a plurality of patient rooms and patient data for patients in each of the plurality of rooms. Such patient data includes at least one medical condition associated with each patient and at least one medical outcome associated with the at least one medical condition. The processor may cause a building system to control an environment of a patient room to have the customized environmental condition based on a determination that the medical condition for the customized environmental condition corresponds to the same medical condition that is associated with a patient in the patient room.

### TECHNICAL FIELD

The present disclosure is directed, in general, to building technology such as systems that control environmental conditions in buildings, and in particular to building systems that control environmental conditions of patient rooms.

### BACKGROUND

Building systems may be used to control environmental conditions in buildings. Such building systems may benefit from improvements.

### SUMMARY

Variously disclosed embodiments include data processing systems and methods that may be used to facilitate optimizing building system control of patient rooms to enhance patient outcomes. In one example, a system may comprise at least one processor configured to determine at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present. The patient data may include at least one medical condition associated with each patient and at least one medical outcome associated with the at least one medical condition. In addition, the at least one processor may cause a building system to control an environment of a first patient room to have the at least one first customized environmental condition based at least in part on a determination that the first medical condition for the at least one first customized environmental condition corresponds to the first medical condition that is associated with a first patient in the first patient room.

In another example, a method for optimizing building system control of patient rooms may comprise through operation of at least one processor, determining at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present. The patient data may include at least one medical condition associated with each patient and at least one medical outcome associated with the at least one medical condition. In addition, through operation of the at least one processor the method may include causing a building system to control an environment of a first patient room to have the at least one first customized environmental condition based at least in part on a determination that the first medical condition for the at least one first customized environmental condition corresponds to the first medical condition that is associated with a first patient in the first patient room.

A further example may include a non-transitory computer readable medium encoded with executable instructions (such as a software component on a storage device) that when executed, causes at least one processor to carry out this described method.

Another example may include an apparatus including at least one hardware, software, and/or firmware based processor, computer, controller, means, module, and/or unit configured to carry out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates optimizing building system control of patient rooms.

FIG. 2 illustrates a further functional block diagram of an example system.

FIG. 3 illustrates a flow diagram of an example methodology that facilitates optimizing building system control of patient rooms.

FIG. 4 illustrates a block diagram of a data processing system in which an embodiment may be implemented.

### DETAILED DESCRIPTION

Various technologies that pertain to systems and methods that facilitate optimizing building system control of patient rooms to enhance patient outcomes will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

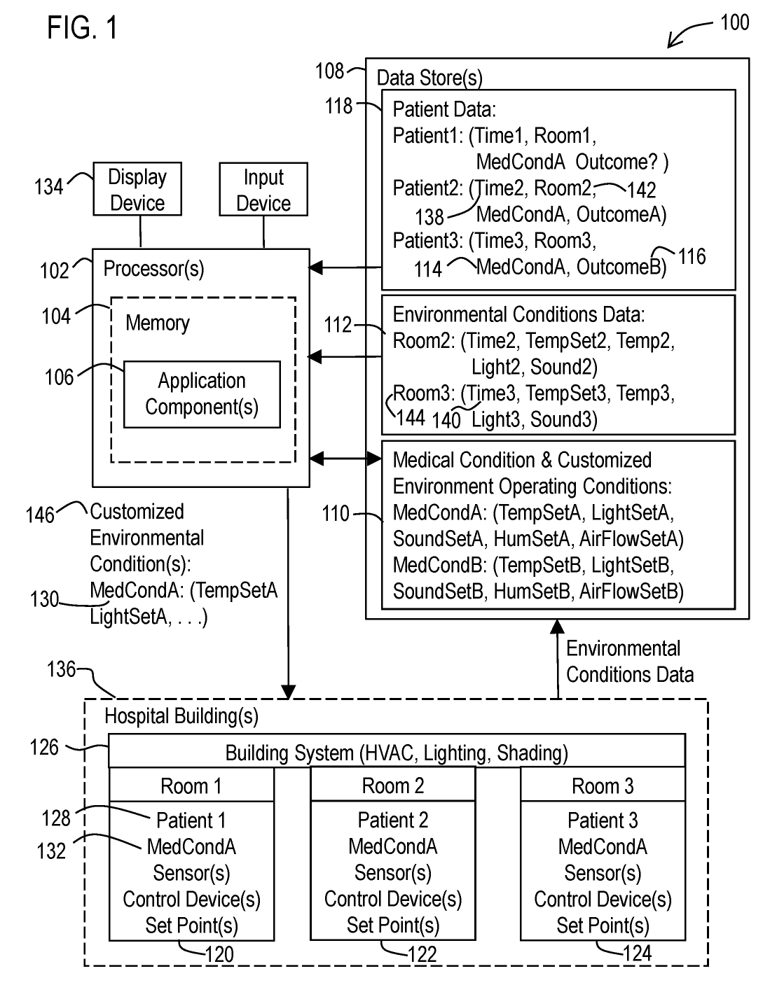

With reference to FIG. 1, an example system 100 is illustrated that facilitates optimizing building system control of patient rooms in order to improve patient outcomes. This example system may be configured to centrally collect and manage individual patient's room environmental conditions in order to leverage this data to produce an optimal healing environment that improves patient outcomes.

The system 100 may include at least one processor 102 that is configured to execute application components 106 (i.e., software, firmware) from a memory 104 accessed by the processor. The application component may be configured (i.e., programmed) to cause the processor to carry out various acts and functions described herein.

The at least one processor 102 may be operative to communicate with one or more data stores 108 such as a database (e.g., Oracle, Microsoft SQL Server), hard drive, SSD, memory card, other type of device that stores non-volatile data, application server, and/or any other type of device or system that is operative to provide data to the at least one processor or is operative to store data received from the at least one processor.

The at least one processor may also be in operative communication with one or more building systems 126 associated with one or more buildings 136 such as a hospital building that includes patient rooms or other medical building that includes patient rooms. Building systems correspond to mechanical/electrical systems that are capable of being controlled by the at least one processor 102 to individually regulate the environmental conditions (e.g., temperature, lighting, shading, sound) in individual patient rooms.

Such building systems may include heating, ventilation, and air conditioning (HVAC) systems. Examples of other building systems include lighting systems that control artificial lighting in patient rooms. Other examples of building systems include shade devices that control the amount of light (such as sunlight) through windows into patient rooms. Further examples of building systems may include sound output devices in a patient rooms (that output white/pink noise and/or masking sounds such as water/rain/wind sounds), air purifies, dehumidifiers, humidifiers, ventilation, or any other type of device that impacts the environment in a patient room and that can be controlled in patient rooms through operation of the at least one processor.

In example embodiments, the system 100 may be configured to improve patient outcomes by modulation of the environmental conditions in patient rooms that are controllable by building systems. To carry out this functionality, the at least one processor 102 may be configured (via one or more application components 106) to determine one or more customized environmental conditions 110 for each medical condition that contributes to a positive medical outcome for the respective medical condition (i.e., a particular medical/health problem of a patient), based at least in part on environmental conditions 112 associated with each of a plurality of patient rooms 120, 122 and patient data 118 for patients in each of the plurality of rooms during time periods for which the environmental conditions were present.

In an example embodiment, the at least one processor may be configured to carry out a statistical analysis based on a wide spectrum of data that represents environment conditions in patient rooms for many patients (e.g., tens, hundreds and/or thousands of different patients) with one or more different medical conditions and the resulting medical outcomes of the medical conditions of these patients. Such a statistical analysis may be carried out to isolate one or more particular environmental conditions which impact the outcome of medical conditions from among other environmental conditions that do not appear to have any statistically significant impact on the medical outcome of the medical condition.

For example, the at least one processor may be operative to evaluate a plurality of different environmental conditions such as levels of temperature, lighting, and sound for a plurality of patents having medical conditions for burns. Based on such an analysis, a hypothetical analysis of such data may determined that a particular temperature range has a statistically significant positive impact on the outcome of the burn, whereas such a hypothetical analysis of such data may reveal that different ranges of sound levels may not provide a statistically significant positive impact on the outcome of the burn.

In an example embodiment, determined customized environmental conditions 110 for a plurality of different medical conditions may be stored in the at least one data store 108. Such customized environmental conditions in the data store 108 may also be updated as more data is statistically analyzed. In addition, such customized environmental conditions in the data store 108 may be reviewed, revised and approved for use by users of the system

When, a patient is admitted to a hospital, the at least one processor may be configured to determine a medical condition for the patient. For example, FIG. 1 illustrates an example of a first patient 128 in the first patient room 120 that may be determined to be associated with a first medical condition 132 (e.g., MedCondA=2^{nd} degree burn). Once the medical condition for the patient is determined, the at least one processor may be configured to retrieve from the data store 108 an appropriate at least one first customized environmental condition 146 (e.g., TempSetA) for the first patient room 120. Such a first customized environmental condition 146 may be retrieved based at least in part on a determination that a first medical condition 130 (e.g., MedCondA=2^{nd} degree burn) for the at least one first customized environmental condition 146 corresponds to the first medical condition 132 (e.g., MedCondA=2^{nd} degree burn) that is associated with the first patient 128 in the first patient room 120. The at least one processor 102 may then cause a building system 126 to control the environment of the first patient room 120 to have the determined customized environmental condition 146 (e.g., temperature set point=TempSetA).

For the previously described hypothetical example, the processor 102 may be configured to determine that the first patient in the first room has a 2^{nd} degree burn medical condition, for example, and responsive thereto cause the building system (such as the HVAC portion of the building system) to maintain a temperature range in the first patient room 120 corresponding to the temperature range for the determined customized environmental condition (e.g. TempSetA) associated with the 2^{nd} degree burn medical condition that was determined to provide a statistically significant positive outcome for burns in general and/or for second degree burns in particular (for this hypothetical example).

In example embodiments, medical conditions associated with patients and for determined customized environmental conditions may correspond to predetermined medical conditions or categories of medical conditions that are usable to determine correspondence between medical conditions for different patients and the determination of the customized environmental conditions. For example, medical conditions may be stored in one or more data stores described herein in a format that corresponds to hospital/insurance/governmental billing codes for medical insurance claims. However, in alternative embodiments the described system may use other or customized predetermined lists of medical conditions to carry out the features described herein.

Also as used herein, particular customized environmental conditions that achieve a statistically significant positive medical outcome may, for example, correspond to a statistical analysis, in which the p-value is less than a significance level of 5% for example, or other significance level or methodology for identifying environmental conditions that do not produce purely random medical outcomes.

In an example, such patient data and environmental data may be stored in the at least one data store 108. Such patient data 118 may include data for a plurality of patients that previously stayed in the patient rooms that are under the control of the hospital building systems described herein. Such patient data may specify at least one medical condition 114 associated with each patient and at least one medical outcome 116 associated with the at least one medical condition. In addition such patient data may specify the time periods that the patient was admitted to the hospital and what patient room(s) that the patient was assigned to.

The environmental condition data 112 stored in the at least one data store 108 may include environmental conditions as set and as measured for different time periods for different patient rooms. For example, the environmental condition data 112 may include set points for building systems with respect to temperature and light as well as measurements made via sensors of actual room temperatures, light exposure levels, audio sound levels or other environmental conditions that were present during time periods that patients were present in the patient rooms.

FIG. 1 schematically illustrates patient data 118 and environmental data 112 stored in different tables. Each of these different tables includes time period data 138, 140 and patient room data 142, 144 which enable the patient data 118 to be correlated with the environmental condition data 112 for purposes of statistically analyzing the data. However, it should be understood that the patient data and environmental condition data may be stored in the same records and/or databases and/or may be stored in separate tables, databases, and/or servers.

In example embodiments, the medical outcomes stored in the patient data may correspond to quantitative and/or qualitative data that indicates the outcome of the medical condition at some point at or after the patient's stay in a patient room under the control of the hospital building systems. Such outcome data, for example, may correspond to data representative of a quality of recovery and/or a rate of recovery.

For example, if the medical condition corresponds to a burn, the outcome data may correspond to a doctor provided medical assessment of how well the burn healed (i.e., the quality of the recovery) based on a scale of 1 to 10, where 1 corresponds to a poor outcome (e.g., excessive scar tissue) and 10 corresponds to a best outcome (e.g., no scarring). Other types of outcome data may qualify or quantify how well the medical condition improved while in the patient room (i.e., a rate of recovery). For example, based on a doctor provided outcome assessment from 1 to 10, a 1 level for such outcome data may indicate that the medical condition worsened, whereas a 10 level for such outcome data may indicate that the medical condition was completely healed at the end of the patients stay in the patient room.

In other examples, the outcome data may include medical measurements relevant to the status of the medical condition. For example, the outcome data for a medical condition such as anemia may include data that captures an initial red blood cell count at the beginning of the patient's stay in the hospital room as well as a final red blood cell count at the end of the patient's stay in the hospital room.

In other examples, the outcome data may include all or a subset set of measurements, medical assessments, or any other data captured from the patient that may provide information useful for determining statistically significant correlations between environmental conditions and positive medical outcomes.

In some example embodiments, one centralized processor (such as a server) may be configured to control the building systems based on determinations made by the same server as to the customized environmental conditions that were determined by the same server to be statistically beneficial for different medical conditions of patients. However, it should be appreciated that in other example embodiments, the described at least one processor may correspond to different processor/servers that carry out different aspects of the described system.

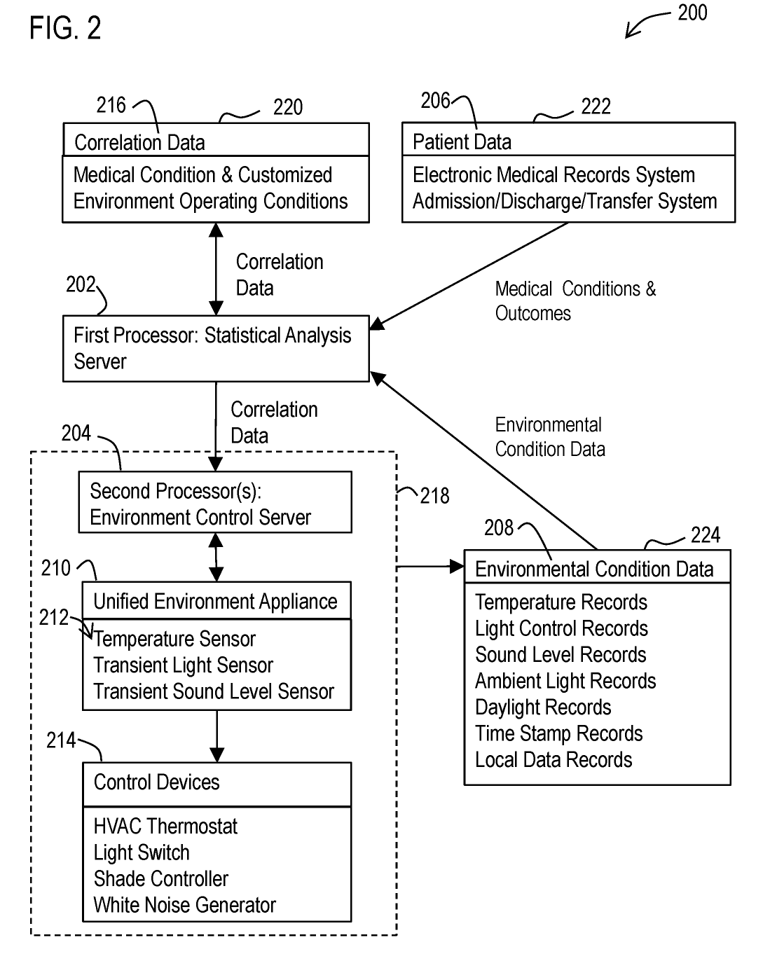

For example, as illustrated in the example system 200 in FIG. 2, the previously described at least one processor may include a first processor 202 and one or more second processors 204. The first processor 202 may correspond to a server executing an application software component that carries out the statistical analysis of patient data 206 and environmental condition data 208 from different data stores 222, 224 accessible to the server. In this example, the first processor 202 may carry out a centralized or converged method of collecting and statistically processing patient room environmental data for many patient rooms. Such a first processor may be configured to correlate patient data 206 with environmental condition data 208 for each patient room to determine correlation data 216 (also stored in at least one data store 220) that corresponds to statistically beneficially optimal set points for temperature, humidity, sound, air change, light level, light quality, and/or other environmental conditions that may improve patient outcomes for different medical conditions.

In this example, the one or more second servers 204 may correspond to environmental control servers associated with different hospital buildings (and/or portions thereof) that control and/or are included by building systems 218 associated with such buildings. Such environmental control servers may be capable of determining one or more conditions of a patient in a particular patient room in the building. In response to this determination, the environmental control server may determine at least one customized environmental condition (e.g., at least one set point) for the particular patient room based on correlation data 216 (generated by the first processor) that specifies customized environmental conditions to use for one or more different medical conditions that match the medical condition(s) of the patient in the particular patient room.

The environmental control server may further be configured to communicate the set points corresponding to the customized environmental conditions to various components of the building systems such as the HVAC system, lighting system, shading system, and sound system. Such components may include a unified environment appliance associated with each room that is configured to interface with the building systems to control the environment in each room. The unified environment appliance may also be in operative connection with control devices 214 in each room via which users (e.g., the patient, medical staff) may modify or further customize the set points for the patient room.

In addition, the described unified environment appliance 210 may further be in operable connection with a plurality of sensors 212 (e.g., a temperature sensor, transient light sensor, transient sound level sensor) associated with each patient room, which are operable to acquire the measurements of environmental conditions in the patient rooms (e.g., temperature, light, and/or sound measurements). Such sensors 212 may be mounted in the room in locations which capture measurements that reflect the actual environmental conditions that the patient in the room is likely to experience.

An example of a unified environment appliance 210 includes a Siemens DXR2.E series compact room automation station. However, it should be appreciated that alternative embodiments may use other types of environment appliances capable of controlling building systems, acquiring measurements from sensors, and interfacing with the described environmental control server 204.

In example embodiments, the environmental control server 204 may be configured to receive the measurements from the unified environment appliance and determine the environmental conditions based on the measurements during time periods that the patients are in the respective patient rooms. The environmental control server 204 may store such measurements (correlated with their patient room and time stamp) as environmental condition data 208 in the data store 224.

In addition, the unified environment appliance 210 may report to the environmental control sever, changes to set points for HVAC systems (e.g., temperature settings), shading configurations, lighting configuration, that are carried out by users (patients, medical staff) for a patient room. The environmental control server 204 may also store such user modified settings for HVAC or other systems (correlated with their patient room and time stamp) as additional environmental condition data 208 in the data store 224. Further, set points communicated by the environmental control sever to the unified environmental appliance and/or building systems may also be stored as additional environmental condition data 208 in the data store 224.

In addition, example embodiments of the environment control sever 204 may store other data in the data store 224 associated with the environmental condition data, such as the user or entity responsible for modifying an environmental condition in a patient room (e.g., a patient, medical staff person). Also, example embodiments of the environment control sever 204 may be configured to further determine and store in the data store 224, environmental condition data based on at least one of outside weather data and daylight data, provided by an external weather server (e.g., a private/governmental weather reporting service), and/or weather/daylight measurement sensors located outside the building.

Thus, examples of environmental condition data that may be captured by sensors, servers, and control devices and stored in the data store 224 associated with a patient room for particular time periods, may include: ambient temperature (measured at one or more locations in the room); temperature set-point changes and associated initiator (patient, clinical staff, programming, automatic changes based on other environmental conditions); temperature trends (i.e., changes in temperature over time); ambient light level measurements (intensity); ambient light quality (wavelength, uniformity); light control input (i.e., what time light was turned on/off, who initiated the change); what light fixtures/zones were activated; natural daylight data, sunrise/sunset data, artificial and variable shading (i.e., electrochromic shading devices); ambient sound level measurement (db levels); location data (i.e., room level, site level, geospatial); motion detection; air pressure; humidity; fresh air refresh rate; air movement level (draftiness); and/or any other data that provides information on environmental conditions that may affect the outcome of a medical condition by a patient.

As discussed previously, the environmental condition data 208 collected in one or more data stores 224 by one or more hospitals may be communicated to the previously described statistical analysis server 202. Such a server may further be operative to collect patient data 206 from one or more data stores 222 associated with one or more hospitals such as electronic medical record systems, admission/discharge/transfer systems, and/or any other type of medical database that stores medical outcomes for particular medical conditions of patients and the particular rooms and time periods in which the patients were present during the treatment of the medical condition.

The statistical analysis server 202 may then be configured via one or more application components to determine (and update) correlation data 216 (stored in one or more data stores 220) that includes correlations between customized environmental conditions and a plurality of different medical conditions based at least in part on the captured environmental condition data 208 (from one or more data stores 224) and the corresponding patient data 206 (from one or more data stores 222). Such correlation data may be compiled and communicated periodically (or at other times) to the environment control servers 204 for use with configuring customized environmental conditions for different medical conditions of patients.

However, in other embodiments, the environmental control server may access the statistical analysis server (or other server or data store 220 that makes the determined correlation data available) in order to acquire all of the determined correlation data or at least portions thereof that are relevant to currently admitted patients.

For example, the environmental control server in a particular hospital may be configured to determine the at least one medical condition and a patient room of each respective patient being admitted to a hospital by accessing the patient data 206 from the data store 222 (e.g., an electronic medical records system and/or an admission/discharge/transfer system). The environmental control server may then query the statistical analysis server 202 (or other server/data store 220) with respect to the determined correlation data 216 in order to access/determine at least one customized environmental condition for a particular condition of each patient being admitted to the hospital. The environmental control server may then cause the building control systems to respectively control environmental conditions of the patient rooms where the patients are being assigned, based at least in part on the determined customized environmental conditions for the patient.

In an example embodiment, the first customized environmental condition may include a first set point for temperature for example. The environmental control server may communicate the set point to the building system (such as the unified environment appliance). The unified environmental appliance may then configure the HVAC for the patient room to the received set point for temperature. Control devices 214 (such as a room temperature control) may receive the set point and cause the temperature for the set point to be displayed via a display device of the control device. A patient room, for example, may include user control devices such as an HVAC thermostat, light switches, and shade controllers.

In example embodiments, some customized environmental conditions may not correspond to set points or other settings that are capable of being automatically configured in a building system to control an environmental condition in a room. Rather some environmental conditions may need to be manually configured. Examples of manual configurations of environmental conditions include noise levels, which may be controlled by keeping a patient's door closed and/or minimizing noisy visits to the patient by hospital staff. Another example of a manual configuration of environmental conditions may include a location of the patient's bed, such as adjacent a window with natural light, or away from direct ventilation air flow.

In order to communicate such manually set environmental conditions, the customized environmental condition may include a textual instruction (or a code that corresponds to textural instructions) that conveys an environmental setting that is manually controlled. The at least one processor 102, the environment control sever 204, the unified environment appliance, or other system, may include or be in operable connection with a display device 134 that is configured to display the textual instruction to manually configure the location of a patient's bed and/or inform medical staff of the need to reduce noise levels and/or interruptions in the patient's room.

In example embodiments, by customizing patient room environmental conditions based on the correlations determined from converged data (from many patients), the system may be capable of improving patient outcomes and lower re-admission rates, which positively impacts the well being of the patient. In addition, improved outcomes may improve patient satisfaction and Hospital Consumer Assessment of Healthcare Providers and Systems (HCAHPS) scores, resulting in better insurance reimbursement for a hospital facility. Also, the collected converged data may further provide data useful for carrying out or evaluating healthcare-related research and clinical treatment protocols.

In addition, it should be understood that the patient data accessed by the statistical analysis server 202 may include personal characteristics of the patient, such as age, weight, gender, medications, and/or any other information that may influence how one or more environmental conditions effects the patient. The statistical analysis server, for example, may use this information to determine different customized environmental conditions for the same medical condition based on personal characteristics of the patient. The Environmental Control Server, may then choose which customized environmental condition to use for a particular patient room based on both the medical condition of the patient and one or more different personal characteristics of the user (e.g., such as weights and/or age).

In addition, it should be understood that the environmental data accessed by the statistical analysis server 202 may include the previously described externally accessed weather or daylight data. The statistical analysis server, for example, may use this information to determine different customized environmental conditions for the same medical condition based on characteristics of outside weather that may impact medical outcomes (sunrise times, outside humidity/temperature). The environmental control server may then choose which customized environmental condition to use for a particular patient room based on both the medical condition of the patient and external characteristics (such as the time of sunrise and the outside humidity/temperature).

Further, it should be appreciated that the collected environment condition data of a patient room may also include other characteristics that impact a patient's outcome, such as the number and/or rate of interruptions by people or devices. For example, the described system may include sensors capable of detecting interruptions by people with presence detectors, such as ultrasonic emitter/sensors, floor pressure sensors and/or any other device capable of detecting people in a patient room. However, in other embodiments, the system may use data collected by the described sound sensor to detect sounds that may correspond to interruptions by people and/or devices (e.g., a loud TV show).

It should also be appreciated that in some example embodiments, the correlation data 216 determined by the statistical analysis server 202 may be manually reviewed, approved, and/or revised before being communicated to or made accessible to the environmental control servers 204. For example, the statistical analysis server may determine that a particular temperature is desirable for a particular medical condition. However, such a temperature may not be practical for some hospital HVAC systems. Thus, such correlation data may be manually modified in a database in which the correlation data is stored in order to be consistent with more hospital HVAC systems.

Also, in some example embodiments the correlation data determined by the statistical analysis server may be supplemented with customized environmental conditions for particular medical conditions that are determined through other sources, such as medical studies, research papers, and/or any other source of data that identify beneficial environment conditions for particular medical conditions.

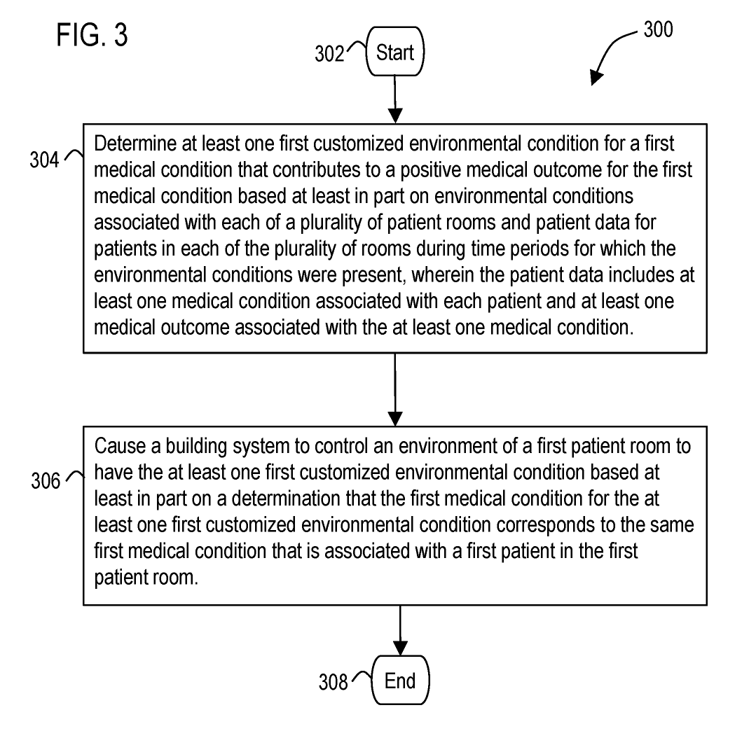

With reference now to FIG. 3, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, and/or the like. Still further, results of acts of the methodologies may be stored in a computer-readable medium, displayed on a display device, and/or the like.

Referring now to FIG. 3, a methodology 300 is illustrated that facilitates optimizing building system control of patient rooms to enhance patient outcomes. The methodology may start at 302 and may include several acts carried out through operation of at least one processor.

These acts may include an act 304 of through operation of at least one processor: determining at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present. Such patient data includes at least one medical condition associated with each patient and at least one medical outcome associated with the at least one medical condition. In addition the methodology may include a step 306 of causing a building system to control an environment of a first patient room to have the at least one first customized environmental condition based at least in part on a determination that the first medical condition for the at least one first customized environmental condition corresponds to the first medical condition that is associated with a first patient in the first patient room. At 308 the methodology may end.

It should be appreciated that the methodology 300 may include other acts and features discussed previously with respect to the processing system 100. For example, the at least one processor may carry out an act of determining the environmental conditions based on a plurality of measurements acquired by a plurality of sensors in the plurality of patient rooms during time periods that the patients are in the respective patient rooms, which measurements include room temperature, light exposure, and audible sound. In this example, the at least one first customized environmental condition may correspond to at least one level for at least one of temperature, light exposure, audible sound, or a combination thereof.

In an example embodiment, the act 306 of causing the building system to control the environment of the first patient room may include causing the building system to control at least one of temperature, light, shade, sound or a combination thereof.

The methodology may also include through operation of the at least one processor, further determining the environmental conditions based on set points for at least one control device of the building system that controls set points for at least one of temperature, light, shade, sound or a combination thereof in the patient rooms.

In an example where the at least one first customized environmental condition includes a first set point for the first room, the act 306 of causing the building system to control the environment of the first patient room may include causing the at least one control device to be set to the first set point.

In addition, in an example embodiment, the at least one first customized environmental condition may further include a textual instruction that conveys an environmental setting that is manually controlled including at least one of location, sound level, or a combination thereof. In such an example, the methodology may include a further act of through operation of the at least one processor causing a display device to output the textual instruction.

An example embodiment of the methodology may further include determining the environmental conditions based on at least one of outside weather data, daylight data, or a combination thereof.

In addition, in examples where the patient rooms are included in a plurality of different hospital buildings, the at least one processor may include at least one first processor and a plurality of second processors. The plurality of second processors may be associated respectively with each of a plurality of building control systems that respectively control environmental conditions of patient rooms in each of the plurality of different hospital buildings.

In such an example embodiment, the methodology may include through operation of the at least one first processor, an act of determining correlation data that includes correlations between customized environmental conditions and a plurality of different medical conditions based at least in part on the determined environmental conditions and the corresponding patient data from the plurality of different hospitals buildings. In addition the methodology may include through operation of the each second processor: an act of accessing the correlation data determined by the at least one first processor; an act of determining at least one medical condition of each respective patient associated with each respective patient room; and act of causing each respective building control system to respectively control the environmental conditions of the patient rooms based at least in part on the accessed correlation data and the determined at least one medical condition of each patient.

In this described methodology, the patient data may be stored in at least one data store. Also the medical outcome associated with each medical condition in the patient data may specify at least one of a rate of recovery, quality of recovery, or a combination thereof. In addition, the at least one data store may include the environmental conditions for the patient rooms. With such a configuration, the methodology may further comprise through operation of the at least one first processor, an act of acquiring the patient data and environmental conditions for the patient rooms from the at least one data store.

As discussed previously, acts associated with these methodologies (other than any described manual acts) may be carried out by one or more processors. Such processor(s) may be included in one or more data processing systems, for example, that execute software components (such as the described application software component) operative to cause these acts to be carried out by the one or more processors. In an example embodiment, such software components may comprise computer-executable instructions corresponding to a routine, a sub-routine, programs, applications, modules, libraries, a thread of execution, and/or the like. Further, it should be appreciated that software components may be written in and/or produced by software environments/languages/frameworks such as Java, JavaScript, Python, C, C#, C++ or any other software tool capable of producing components and graphical user interfaces configured to carry out the acts and features described herein.

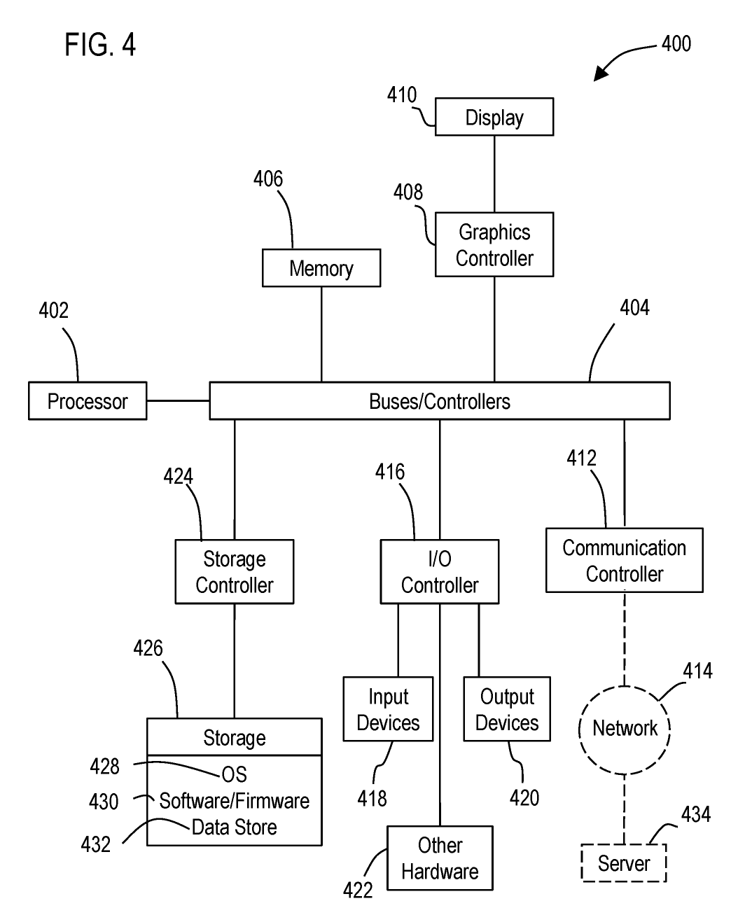

FIG. 4 illustrates a block diagram of a data processing system 400 (also referred to as a computer system) in which an embodiment can be implemented, for example, as a portion of a building system, and/or other system operatively configured by software/firmware or otherwise to perform the processes as described herein. The data processing system depicted includes at least one processor 402 (e.g., a CPU) that may be connected to one or more bridges/controllers/buses 404 (e.g., a north bridge, a south bridge). One of the buses 404, for example, may include one or more I/O buses such as a PCI Express bus. Also connected to various buses in the depicted example may include a main memory 406 (RAM) and a graphics controller 408. The graphics controller 408 may be connected to one or more display devices 410. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 412 (Ethernet controllers, WiFi controllers, cellular controllers) operative to connect to a local area network (LAN), Wide Area Network (WAN), a cellular network, and/or other wired or wireless networks 414 or communication equipment.

Further components connected to various busses may include one or more I/O controllers 416 such as USB controllers, Bluetooth controllers, and/or dedicated audio controllers (connected to speakers and/or microphones). It should also be appreciated that various peripherals may be connected to the I/O controller(s) (via various ports and connections) including input devices 418 (e.g., keyboard, mouse, pointer, touch screen, touch pad, drawing tablet, trackball, buttons, keypad, game controller, gamepad, camera, microphone, scanners, motion sensing devices that capture motion gestures), output devices 420 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 402 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 422 connected to the I/O controllers 416 may include any type of device, machine, or component that is configured to communicate with a data processing system.

Additional components connected to various busses may include one or more storage controllers 424 (e.g., SATA). A storage controller may be connected to a storage device 426 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 404 such as a PCI Express bus.

A data processing system in accordance with an embodiment of the present disclosure may include an operating system 428, software/firmware 430, and data stores 432 (that may be stored on a storage device 426 and/or the memory 406). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 412 may be connected to the network 414 (not a part of data processing system 400), which can be any public or private data processing system network or combination of networks, as known to those of skill in the art, including the Internet. Data processing system 400 can communicate over the network 414 with one or more other data processing systems such as a server 434 (also not part of the data processing system 400). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 402 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 400 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 400 may conform to any of the various current implementations and practices known in the art.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A system for optimizing building system control of patient rooms comprising:
at least one processor configured to:
determine at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present, wherein the patient data includes at least one medical condition associated with each patient and at least one medical outcome associated with the at least one medical condition;
cause a building system to control an environment of a first patient room to have the at least one first customized environmental condition based at least in part on a determination that the first medical condition for the at least one first customized environmental condition corresponds to the first medical condition that is associated with a first patient in the first patient room.

2. The system according to claim 1, further comprising a plurality of sensors in the plurality of patient rooms, which are operable to acquire the measurements, wherein the at least one processor is configured to determine the environmental conditions based on the measurements during time periods that the patients are in the respective patient rooms, which measurements include room temperature, light exposure, and audible sound, wherein the at least one first customized environmental condition corresponds to at least one level for at least one of temperature, light exposure, audible sound, or a combination thereof.

3. The system according to claim 2, further comprising the building system that is operable to control at least one of temperature, light, shade, sound, or any combination thereof in the patient rooms, wherein the at least one processor is configured to determine further environmental conditions for each room including set points for at least one control device of the building system that controls set points for at least one of temperature, light, shade, sound, or any combination thereof in the patient rooms.

4. The system according to claim 3, wherein the at least one first customized environmental condition includes a first set point for the first room, wherein the building system is operable to set the at least one control device to the first set point based on the first customized environmental condition, wherein the at least one first customized environmental condition further includes a textual instruction that conveys an environmental setting that is manually controlled including at least one of location, sound level, or a combination thereof, wherein the at least one processor is configured to cause a display device to output the textual instruction.

5. The system according to claim 3, wherein the at least one processor is configured to further determine the environmental conditions based on at least one of outside weather data, daylight data, or a combination thereof.

6. The system according to claim 3, wherein the patient rooms are included in a plurality of different hospital buildings, wherein the at least one processor includes at least one first processor that is configured to determine correlation data that includes correlations between customized environmental conditions and a plurality of different medical conditions based at least in part on the determined environmental conditions and the corresponding patient data from the plurality of different hospitals buildings, wherein the at least one processor further includes a plurality of second processors associated respectively with each of a plurality of building control systems that respectively control environmental conditions of patient rooms in each of the plurality of different hospital buildings, wherein each second processor is configured to determine the at least one medical condition of each respective patient associated with each respective patient room, wherein each second processor is configured to access the environment-condition correlation data determined by the at least one first processor, wherein each second processor is configured to cause each respective building control system to respectively control environmental conditions of the patient rooms based at least in part on the accessed environment-condition correlation data and the determined at least one medical condition of each patient.

7. The system according to claim 6, wherein the patient data is stored in at least one data store (108, 206, 208), wherein the medical outcome associated with each medical condition in the patient data specifies at least one of a rate of recovery, quality of recovery, or a combination thereof, wherein the at least one data store includes the environmental conditions for the patient rooms, wherein the at least one first processor is configured to acquire the patient data and environmental conditions for the patient rooms from the at least one data store.

8. A method for optimizing building system control of patient rooms comprising:
through operation of at least one processor:
determining at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present, wherein the patient data includes at least one medical condition associated with each patient and at least one medical outcome associated with the at least one medical condition;
causing a building system to control an environment of a first patient room to have the at least one first customized environmental condition based at least in part on a determination that the first medical condition for the at least one first customized environmental condition corresponds to the first medical condition that is associated with a first patient in the first patient room.

9. The method according to claim 8, further comprising through operation of the at least one processor determining the environmental conditions based on a plurality of measurements acquired by a plurality of sensors in the plurality of patient rooms during time periods that the patients are in the respective patient rooms, which measurements include room temperature, light exposure, and audible sound, wherein the at least one first customized environmental condition corresponds to at least one level for at least one of temperature, light exposure, audible sound, or a combination thereof.

10. The method according to claim 9, wherein causing the building system to control the environment of the first patient room includes causing the building system to control at least one of temperature, light, shade, sound or a combination thereof, wherein through operation of the at least one processor, further determining the environmental conditions based on set points for at least one control device of the building system that controls set points for at least one of temperature, light, shade, sound or a combination thereof in the patient rooms.

11. The method according to claim 10, wherein the at least one first customized environmental condition includes a first set point for the first room, wherein causing the building system to control the environment of the first patient room includes causing the at least one control device to be set to the first set point, wherein the at least one first customized environmental condition further includes a textual instruction that conveys an environmental setting that is manually controlled including at least one of location, sound level, or a combination thereof, further comprising through operation of the at least one processor causing a display device to output the textual instruction.

12. The method according to claim 10, through operation of the at least one processor, further determining the environmental conditions based on at least one of outside weather data, daylight data, or a combination thereof.

13. The method according to claim 10, wherein the patient rooms are included in a plurality of different hospital buildings, wherein the at least one processor includes at least one first processor and a plurality of second processors, wherein the plurality of second processors are associated respectively with each of a plurality of building control systems that respectively control environmental conditions of patient rooms in each of the plurality of different hospital buildings, further comprising:
through operation of the at least one first processor, determining correlation data that includes correlations between customized environmental conditions and a plurality of different medical conditions based at least in part on the determined environmental conditions and the corresponding patient data from the plurality of different hospitals buildings;
through operation of each second processor:
accessing the correlation data determined by the at least one first processor,
determining at least one medical condition of each respective patient associated with each respective patient room,
causing each respective building control system to respectively control the environmental conditions of the patient rooms based at least in part on the accessed correlation data and the determined at least one medical condition of each patient.

14. The method according to claim 13, wherein the patient data is stored in at least one data store, wherein the medical outcome associated with each medical condition in the patient data specifies at least one of a rate of recovery, quality of recovery, or a combination thereof, wherein the at least one data store includes the environmental conditions for the patient rooms, further comprising through operation of the at least one first processor, acquiring the patient data and environmental conditions for the patient rooms from the at least one data store.

15. A non-transitory computer readable medium encoded with executable instructions that when executed, cause at least one processor to carry out a method comprising:
through operation of the at least one processor:
determining at least one first customized environmental condition for a first medical condition that contributes to a positive medical outcome for the first medical condition based at least in part on environmental conditions associated with each of a plurality of patient rooms and patient data for patients in each of the plurality of rooms during time periods for which the environmental conditions were present, wherein the patient data includes at least one medical condition associated with each patient and at least one medical outcome associated with the at least one medical condition;
causing a building system to control an environment of a first patient room to have the at least one first customized environmental condition based at least in part on a determination that the first medical condition for the at least one first customized environmental condition corresponds to the first medical condition that is associated with a first patient in the first patient room.

16. The computer readable medium according to claim 15, further comprising through operation of the at least one processor determining the environmental conditions based on a plurality of measurements acquired by a plurality of sensors in the plurality of patient rooms during time periods that the patients are in the respective patient rooms, which measurements include room temperature, light exposure, and audible sound, wherein the at least one first customized environmental condition corresponds to at least one level for at least one of temperature, light exposure, audible sound, or a combination thereof.

17. The computer readable medium according to claim 16, wherein causing the building system to control the environment of the first patient room includes causing the building system to control at least one of temperature, light, shade, sound or a combination thereof, wherein through operation of the at least one processor, further determining the environmental conditions based on set points for at least one control device of the building system that controls set points for at least one of temperature, light, shade, sound or a combination thereof in the patient rooms.

18. The computer readable medium according to claim 17, wherein the at least one first customized environmental condition includes a first set point for the first room, wherein causing the building system to control the environment of the first patient room includes causing the at least one control device to be set to the first set point, wherein the at least one first customized environmental condition further includes a textual instruction that conveys an environmental setting that is manually controlled including at least one of location, sound level, or a combination thereof, further comprising through operation of the at least one processor causing a display device to output the textual instruction.

19. The computer readable medium according to claim 17, through operation of the at least one processor, further determining the environmental conditions based on at least one of outside weather data, daylight data, or a combination thereof.

20. The computer readable medium according to claim 17, wherein the patient rooms are included in a plurality of different hospital buildings, wherein the at least one processor includes at least one first processor and a plurality of second processors, wherein the plurality of second processors are associated respectively with each of a plurality of building control systems that respectively control environmental conditions of patient rooms in each of the plurality of different hospital buildings, wherein the patient data is stored in at least one data store, wherein the medical outcome associated with each medical condition in the patient data specifies at least one of a rate of recovery, quality of recovery, or a combination thereof, wherein the at least one data store includes the environmental conditions for the patient rooms, further comprising:
through operation of the at least one first processor, acquiring the patient data and environmental conditions for the patient rooms from the at least one data store. through operation of the at least one first processor, determining correlation data that includes correlations between customized environmental conditions and a plurality of different medical conditions based at least in part on the determined environmental conditions and the corresponding patient data from the plurality of different hospitals buildings;
through operation of each second processor:
accessing the correlation data determined by the at least one first processor,
determining at least one medical condition of each respective patient associated with each respective patient room,
causing each respective building control system to respectively control the environmental conditions of the patient rooms based at least in part on the accessed correlation data and the determined at least one medical condition of each patient.
